(19) United States
(12) Patent Application Publication
(10) Pub. No.: US 2009/0296750 A1
(43) Pub. Date: Dec. 3, 2009

(54) Two-Color Double-Pulsed Laser for the Ignition of an Internal Combustion Engine

(76) Inventor: Heiko Ridderbusch, Schwieberdingen (DE)

Correspondence Address: KENYON & KENYON LLP, ONE BROADWAY, NEW YORK, NY, 10004, US

(21) Appl. No.: 12/227,748

(22) PCT Filed: May 22, 2007
(86) PCT No.: PCT/EP2007/054938

§ 371 Date: Aug. 10, 2009

(30) Foreign Application Priority Data
Jul. 11, 2006 (DE) 10 2006 031 947.8

(51) Int. Cl. H01S 3/11

(52) U.S. Cl. 372/14

(57) ABSTRACT

A laser device having a cavity which has a first laser-active region and at least one second laser-active region having a passive Q-switch as well as mirrors bound the cavity, the first laser-active region emitting light of a first wavelength, as a result of having pumping light applied to it, for which the cavity is developed as a resonator. The second laser-active region, having the passive Q-switch, in turn emits the light of a second wavelength, as a result of the application of the light of the first wavelength. The cavity is also developed as a resonator for the light of the second wavelength.

### BACKGROUND INFORMATION

The present invention relates to a laser device having a cavity which has a first laser-active region and at least one second laser-active region having a passive Q-switch as well as mirrors bounding the cavity, the first laser-active region emitting light of a first wavelength, as a result of having pumping light applied to it, for which the cavity is developed as a resonator. Such laser devices are used for generating relatively short laser pulses having a relatively high intensity.

### SUMMARY

It is an object of the present invention to improve a laser device, of the type mentioned at the outset, to the extent that it has an increased efficiency.

This object may be attained by an example embodiment of the present invention in that the second laser-active region, having the passive Q-switch, in turn emits light of a second wavelength as a result of having light of the first wavelength applied to it, and in that the cavity is also developed as a resonator for the light of the second wavelength.

Because of the development of the cavity as a resonator also for the light of the second wavelength, according to the example embodiment of the present invention, the possibility advantageously exists of being able also to utilize the optical radiation power, emitted by the first laser-active region, that was used for the optical fading of the passive Q-switch, for generating laser pulses.

In the usual laser devices that have a passive Q-switch that are designed, for instance, as a saturable absorber, the transmission of the passive Q-switch or the saturable absorber is a function of an irradiated radiation intensity. With an increasing radiation intensity, more and more electrons of a medium of the second laser-active region or the passive Q-switch are pumped into an excited state, from which, among other things, they pass over again into the ground state. As soon as the corresponding population numbers at the excited level are reached, the saturable absorber appears transparent, so that finally a laser oscillation is able to kick in.

The optical radiation energy used for the fading of the saturable absorber is not utilized further in the usual laser devices, and is lost in the form of spontaneously emitted photons or lattice vibrations (phonons).

By contrast, the configuration, according to the example embodiment of the present invention, of the cavity as resonator both for the first and for the second wavelength, makes possible that the light emitted by the passive Q-switch or the second laser-active region may be used to form a laser pulse. That is, the cavity of the laser device according to the present invention is developed as a double cavity, as it were, and makes possible the generation of a first laser pulse at the first wavelength in a conventional manner, and in addition, also the generation of a second laser pulse at the second wavelength. Because of that, advantageously the light emitted by the second laser-active region is also utilized, and the efficiency of the laser device is correspondingly increased.

Additional features, possible uses and advantages of the present invention are derived from the description of exemplary embodiments of the present invention below and the figures. All of the features described or illustrated constitute the subject matter of the present invention either alone or in any combination, regardless of the way they are combined, and regardless of their representation in the description or the figures.

### BRIEF DESCRIPTION OF THE DRAWINGS

FIG. 1 shows a schematic illustration of an internal combustion engine having an ignition device according to an example embodiment of the present invention.

FIG. 2 shows a specific embodiment of the laser device according to the present invention in detail.

FIG. 3 shows a diagram which reflects schematically the curve over time of two laser pulses emitted by the example laser device according to the present invention.

### DETAILED DESCRIPTION OF EXAMPLE EMBODIMENTS

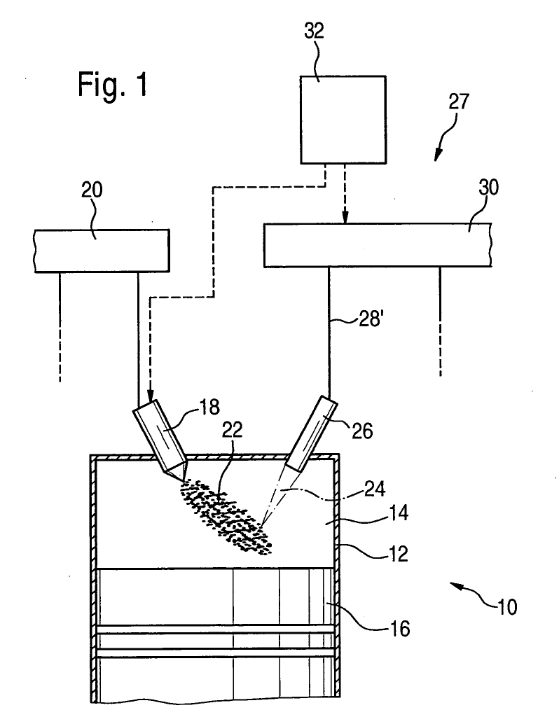

In FIG. 1, an internal combustion engine in its entirety bears reference numeral 10. It is used for driving a motor vehicle. Internal combustion engine 10 includes a plurality of cylinders, of which only one, having a reference numeral 12, is shown in FIG. 1. A combustion chamber 14 of cylinder 12 is bounded by a piston 16. Fuel reaches combustion chamber 14 directly through an injector 18, which is connected to a fuel pressure reservoir 20 that is also designated as a rail, or rather, common rail.

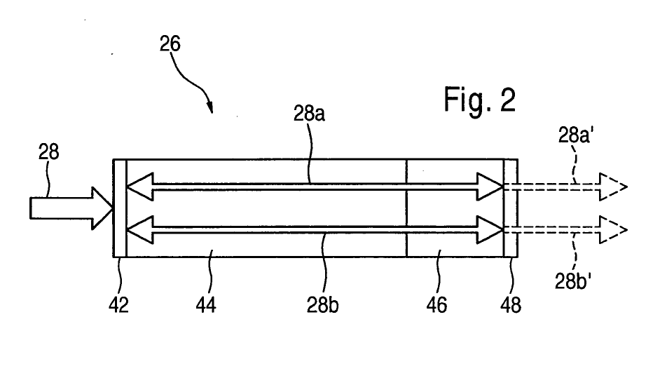

Fuel 22 injected into combustion chamber 14 is ignited using a laser pulse 24, which is eradiated into combustion chamber 14 by an ignition device 27 that includes a laser device 26. For this purpose, laser device 26 according to the present invention is fed, for instance, via a light guide device 28′, with a pumping light 28 (FIG. 2) that is provided by a pumping light source 30. Pumping light source 30 is controlled by a control and regulating device 32, which also activates injector 18.

Pumping light source 30 may be a semiconductor laser diode, for instance, which, as a function of a control current, emits an appropriate pumping light 28 via light guide device 28′ to laser device 26. Although semiconductor laser diodes, and other pumping light sources that take up little space, are preferred for use in the motor vehicle field, for the purpose of operating ignition device 27 according to the example embodiment of the present invention, every type of pumping light source is usable, in principle.

As may be seen in the detailed illustration in FIG. 2, laser device 26, according to an example embodiment of the present invention, has a cavity which is formed from a first laser-active region 44 and a second laser-active region 46 adjacent to it, and mirrors 42, 48 that bound the cavity.

First laser-active region 44 has, for instance, a laser-active medium that has a neodymium-doped or an ytterbium-doped host material. Second laser-active region 46 has, for example, a laser-active medium that has a Cr⁴⁺-doped host material and forms a passive Q-switch for the cavity 42, 44, 46, 48.

When a pumping light 28 is applied to laser device 26, according to the present invention, or rather, to first laser-active region 44 situated inside of it, first laser-active region 44 emits light 28a of a first wavelength. With respect to its geometry and the nature of mirrors 42, 48 that bound it, cavity 42, 44, 46, 48 is developed in such a way that it acts as a resonator for light 28a of the first wavelength. This means that, as soon as the passive Q-switch in second laser-active region 46 has been sufficiently faded out by a sufficiently strong irradiation with light 28a of the first wavelength, a laser oscillation is able to develop at the first wavelength in cavity 42, 44, 46, 48. These circumstances are shown by double arrow 28a illustrated in FIG. 2, which extends between mirrors 42, 48 that bound the cavity.

In order to implement the described functionality of the resonator, mirror 42, that is situated on the left in FIG. 2, is developed in such a way that it has a high reflectivity for light 28a of the first wavelength. By the term “high reflectivity” one should understand, in the present case, especially a reflectivity that is as high as possible, or is the maximum achievable, so as to avoid transmission losses of light 28a of the first wavelength by mirror 42.

In order to make possible the coupling out of laser pulse 28a′, made up of light 28a of the first wavelength, from the resonator or cavity 42, 44, 46, 48, second mirror 48 is developed in such a way that it has transmission for light 28a of the first wavelength that differs from zero percent. Favorable values for the transmission reach from about 1 percent to about 80 percent.

It is particularly advantageous if cavity 42, 44, 46, 48 of laser device 26, according to the present invention, is further developed in such a way that it also forms a resonator for light 28b of a second wavelength.

Light 28b of the second wavelength is created in second laser-active region 46, that has the passive Q-switch, in that electrons of a laser-active medium located in region 46 are set into an excited state using light 28a, of the first wavelength, that is emitted by first laser-active region 44, and for a while go over into the ground state again by spontaneous emission, correspondingly emitting light 28b of the second wavelength.

Because of the development, according to the example embodiment of the present invention, of cavity 42, 44, 46, 48 as a resonator also for light 28b of the second wavelength, accordingly in cavity 42, 44, 46, 48 a laser oscillation of light 28b of the second wavelength is also able to develop, which is shown in FIG. 2 by double arrow 28b.

In order also to be able to couple laser light 28b, of the second wavelength, in the form of a laser pulse 28b′ from laser device 26 into combustion chamber 14 of internal combustion engine 10, for instance, mirror 48 preferably also demonstrates a transmission for laser light 28b of the second wavelength that is different from zero percent.

The laser pulses generated by laser device 26 and coupled out from cavity 42, 44, 46, 48 are symbolized by dashed arrows 28a′, 28b′.

One advantage of laser device 26, according to the present invention, is that otherwise unused photons of the second wavelength, which are created in second laser-active region 46 having the passive Q-switch, are also used for generating a corresponding laser oscillation, and thus for generating a laser pulse 28b′. This raises the efficiency of laser device 26, according to the present invention, as opposed to the usual laser devices, in which the photons generated in the second laser-active region of the passive Q-switch are not used at all.

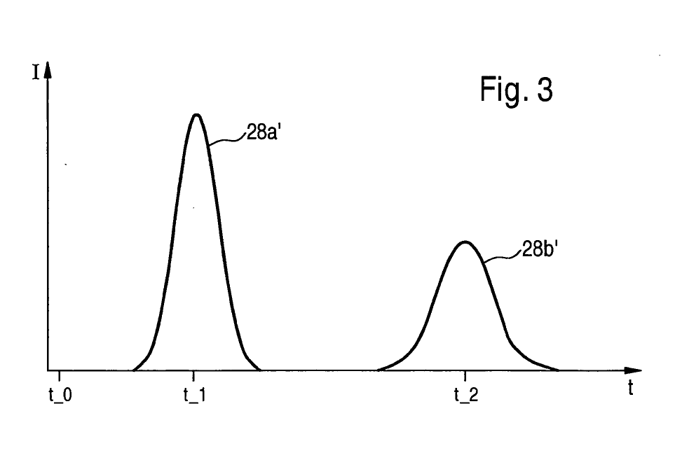

In a further specific embodiment of the laser device, according to the present invention, that is very advantageous, it is provided that at least one of mirrors 42, 48 that bound cavity 42, 44, 46, 48 has a different reflectivity for light 28a, 28b of the first or the second wavelength. Because of this, one is able to specify a different transient response and operating response in the generation of laser light 28a, 28b as a function of the corresponding wavelengths, whereby the sequence in time of laser pulses 28a′, 28b′ can be controlled, among other things. Such a sequence in time is described below in the form of an example, with reference to the diagram shown in FIG. 3.

Time is plotted on the abscissa of the diagram shown in FIG. 3, while the ordinate gives an intensity I of generated laser pulses 28a′, 28b′. At a first point in time t_0, pumping light 28 is applied to laser device 26, or rather, first laser-active region 44 of laser device 26, according to the present invention, whereby a population inversion builds up in first laser-active region 44, in a known manner. As soon as the passive Q-switch in second laser-active region 46 has been sufficiently faded out, a laser oscillation comes about, in the manner already described, at the first wavelength of light 28a, and a corresponding first laser pulse 28a′ is coupled out of laser device 26 at time t_1, according to the present invention.

Since light 28b emitted from second laser-active region 46 is advantageously also used for laser pulses 28b′, according to the present invention, after the emission of first laser pulse 28a′ at time t_1, an additional laser pulse 28b′ is also generated at time t_2, which however, by contrast to first laser pulse 28a′, does not have the first wavelength but has the second wavelength.

To operate above-described laser device 26 according to the example embodiment of the present invention, one may use pumping light 28 having a wavelength of about 800 nanometers, for example. Light 28a, emitted by first laser-active region 44 in reaction to the application of pumping light 28, accordingly has a wavelength of about 1000 nanometers, for example, and light 28b, which is eradiated by second laser-active region 46 in reaction to the application of laser light 28a of the first wavelength, has a wavelength of about 1400 nanometers.

Besides the increased effectiveness in the conversion of pumping light 28 into laser pulses 28a′, 28b′, generating two successive laser pulses 28a′, 28b′ also represents an advantageous design approach to increasing the reliability in the ignition process of fuel 22 located in combustion chamber 14.

The principle according to the present invention is not limited to the use for internal combustion engines of motor vehicles, but may also particularly be advantageously used in stationary engines. Other fields of application than the use of laser device 26 in an ignition device are also conceivable.

Using pumping light 28 of different wavelengths is also possible. Beyond that, one may imagine providing additional laser-active regions in cavity 42, 44, 46, 48. Furthermore, it is possible to place an optical amplifier (not shown) downstream from laser device 26 according to the present invention.

1-9. (canceled)

10. A laser device having a cavity which has a first laser-active region and at least one second laser-active region having a passive Q-switch, the laser device including mirrors bounding the cavity, the first laser-active region adapted to emit light of a first wavelength as a result of having pumping light applied to it, for which the cavity is a resonator, the second laser-active region having the passive Q-switch, adapted to emit light of a second wavelength as a result of an application of light of the first wavelength, the cavity also being a resonator for the light of the second wavelength.

11. The laser device as recited in claim 10, wherein at least one of the mirrors that bound the cavity has a high transmission for the pumping light.

12. The laser device as recited in claim 10, wherein at least one of the mirrors that bound the cavity has a high reflectivity for light of at least one of the first and the second wavelength.

13. The laser device as recited in claim 10, wherein one of the mirrors that bound the cavity has a reflectivity for light of at least one of the first and the second wavelength, of about 20 percent to about 100 percent.

14. The laser device as recited in claim 10, wherein at least one of the mirrors that bound the cavity has a different reflectivity for light of the first and the second wavelength.

15. The laser device as recited in claim 10, wherein the first laser-active region has a laser-active medium that has a neodymium-doped or an ytterbium-doped host material.

16. The laser device as recited in claim 10, wherein the second laser-active region having the passive Q-switch has a laser-active medium which has a Cr⁴⁺-doped host material.

17. An ignition device for an internal combustion engine of a motor vehicle, the ignition device comprising:
at least one laser device having a cavity which has a first laser-active region and at least one second laser-active region having a passive Q-switch, the laser device including mirrors bounding the cavity, the first laser-active region adapted to emit light of a first wavelength as a result of having pumping light applied to it, for which the cavity is a resonator, the second laser-active region having the passive Q-switch, adapted to emit light of a second wavelength as a result of an application of light of the first wavelength, the cavity also being a resonator for the light of the second wavelength.

18. A method for generating laser pulses, comprising:
providing a laser device, the laser device having a cavity which has a first laser-active region and at least one second laser-active region having a passive Q-switch, the laser device including mirrors bounding the cavity, the first laser-active region adapted to emit light of a first wavelength as a result of having pumping light applied to it, for which the cavity is a resonator, the second laser-active region having the passive Q-switch, adapted to emit light of a second wavelength as a result of an application of light of the first wavelength, the cavity also being a resonator for the light of the second wavelength; and
applying a pumping light of at least one wavelength to the laser device, the pumping light being applied for a specifiable time.
